(19) United States
(12) Patent Application Publication
(10) Pub. No.: US 2008/0174703 A1
(43) Pub. Date: Jul. 24, 2008

(54) Sensing modulator

(76) Inventor: Arthur R. Piehl, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/655,503

(22) Filed: Jan. 18, 2007

(51) Int. Cl. H04N 9/31

(52) U.S. Cl. 348/744; 348/E09.025

(57) ABSTRACT

A sensing modulator is disclosed. The sensing modulator includes a light modulator array and a plurality of photosensors, each of the plurality of photosensors being adjacent to the light modulator array.

### BACKGROUND

Tiled projection digital display systems use multiple projectors to produce a large, high resolution image. In many known systems, multiple screens are placed next to each other to form a large image display. A problem with many of the multi-projector display systems is that the multiple images often do not appear as one single continuous image on the display screen. When multiple images are projected on a single screen, typically the composite image includes alignment errors and optical distortions. In the composite image, often there are seams or bright lines between the multiple images. Consequently, a need exists for an improved method for aligning multi-projector display systems.

### BRIEF DESCRIPTION OF THE DRAWINGS

FIG. 1 illustrates a sensing modulator in accordance with an embodiment.

FIG. 2 is a high-level flowchart of a method for displaying at least two projected overlapping images in accordance with an embodiment.

FIG. 3 is an illustration of an image projection device in accordance with an embodiment.

FIG. 4 shows how the sensing modulator is re-imaged onto a projection surface in accordance with an embodiment.

FIG. 5 shows a multi projector display system in accordance with an embodiment.

FIG. 6 shows two overlapping projected arrays on a screen in accordance with an embodiment.

### DETAILED DESCRIPTION

As shown in the drawings for purposes of illustration, a sensing modulator and a method of use thereof is disclosed. In an embodiment, the sensing modulator includes a light modulator array and a plurality of photosensors wherein each of the plurality of photosensors are adjacent to the light modulator array. Accordingly, the modulator provides for the registration of multiple projection images to within 1 pixel as well as brightness and color calibration between the images. From the end user perspective, no hardware is needed other than the individual projectors and the only setup procedure required is to guarantee that the multiple projected images overlap.

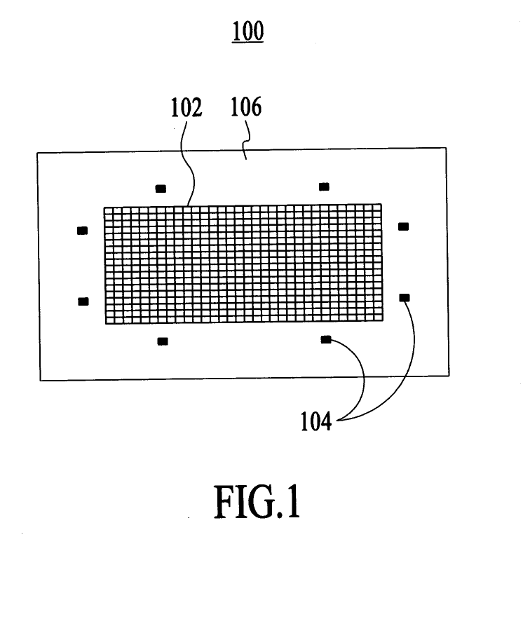

FIG. 1 illustrates a sensing modulator 100 in accordance with an embodiment. The modulator includes an active light modulator array 102 and a plurality of photosensors 104. The light modulator array 102 and the plurality of photosensors 104 are on a light blocking layer 106. In varying embodiments, the photosensors can be silicon photodiodes or phototransistors designed in the underlying Complementary Metal Oxide Semiconductor (CMOS) process.

A CMOS-based image sensor is a chip that records the intensities of light as variable charges similar to a charge-couple device (CCD) chip. Although initially used in less expensive digital cameras, the quality of CMOS sensors has improved steadily. Additionally, CMOS sensors have advantages over CCDs. They can be made like other CMOS chips on standard CMOS fabrication lines. As a result, no additional masking steps or process changes would be necessary which makes development less costly, and auxiliary circuitry, such as analog-to-digital conversion, can be combined on the same chip.

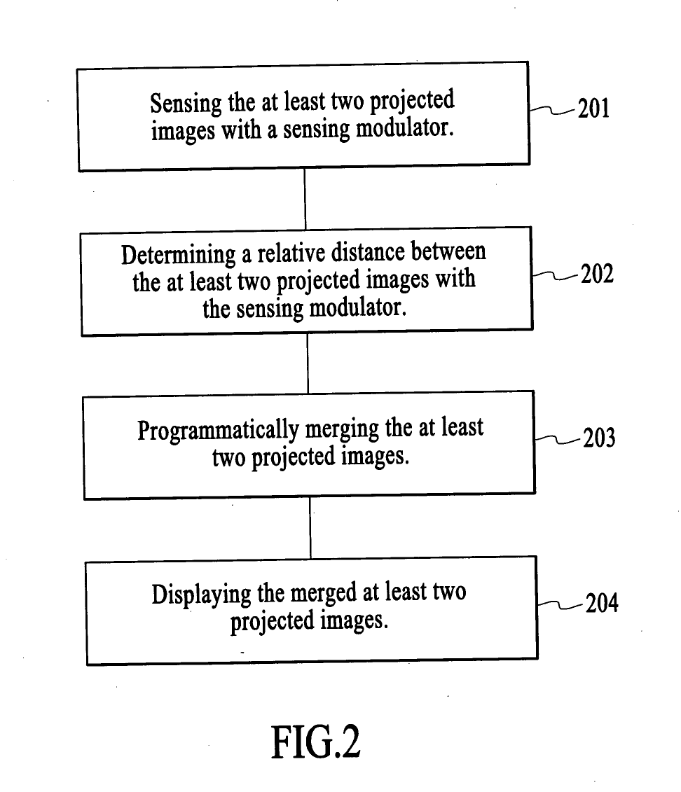

As previously articulated, varying embodiments of this concept include a method for displaying at least two projected overlapping images. By ascertaining the relative positions of the two projected images, the overlapping pixels can be removed or merged together programmatically. FIG. 2 is a high-level flowchart of a method for displaying at least two projected overlapping images in accordance with an embodiment. A first step 201 involves sensing the at least two projected images with a sensing modulator. A next step 202 includes determining a relative distance between the at least two projected images with the sensing modulator. Step 203 involves programmatically merging the at least two projected images. A final step 204 includes displaying the merged at least two projected images.

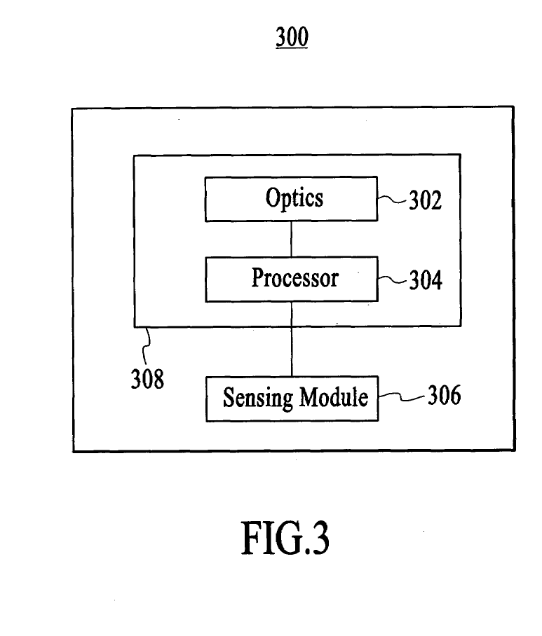

In order to accomplish the above-delineated method, the above described sensing modulator is employed in conjunction with an image projection device. Accordingly, FIG. 3 is an illustration of an image projection device 300 in accordance with an embodiment. The device 300 includes projection optics 302, a projector control processor 304, and at least one sensing modulator 306 wherein the projection optics 302 and the at least one sensing modulator 306 are coupled to the projector control processor 304. The projection optics 302 and the projector control processor 304 constitute an image processing mechanism 308 whereby the projector control processor 304 applies image data and control signals to the projection optics 302.

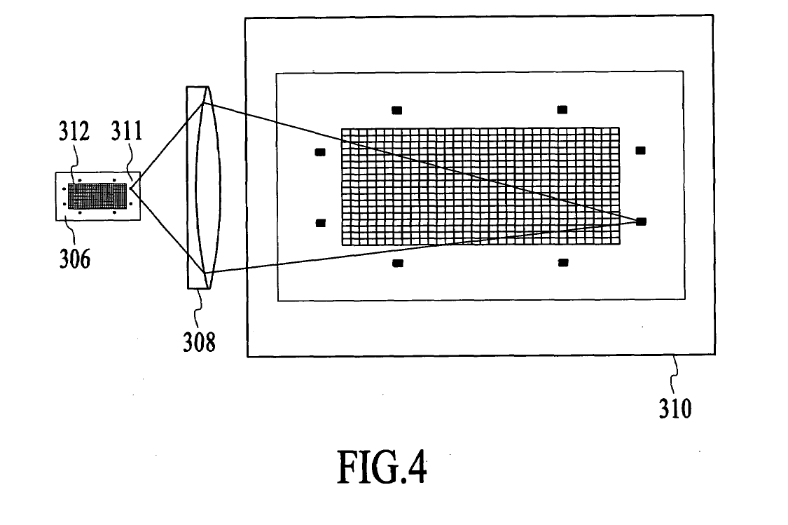

The image projecting mechanism 308 is employed to re-image the sensing modulator onto a projection surface. FIG. 4 shows how the sensing modulator is imaged onto a projection surface. FIG. 4 shows the sensing modulator 306, the image projection mechanism 308 and a projection surface 310. During the operation of the image projection device, the active array 312 is imaged onto the projection surface 310. The projection surface positions shown are re-imaged onto the photosensors 311 outside of the active array 312 with the image projection mechanism 308. The projection surface positions that are re-imaged onto the photosensors correspond to positions illuminated be any adjacent projector. Accordingly, once the photosensor 311 picks up a signal from an adjacent projected overlapping image, the relative position of the projected overlapping images can be determined to within one pixel because the position of the photosensor 311 with respect to the active array 312 is known.

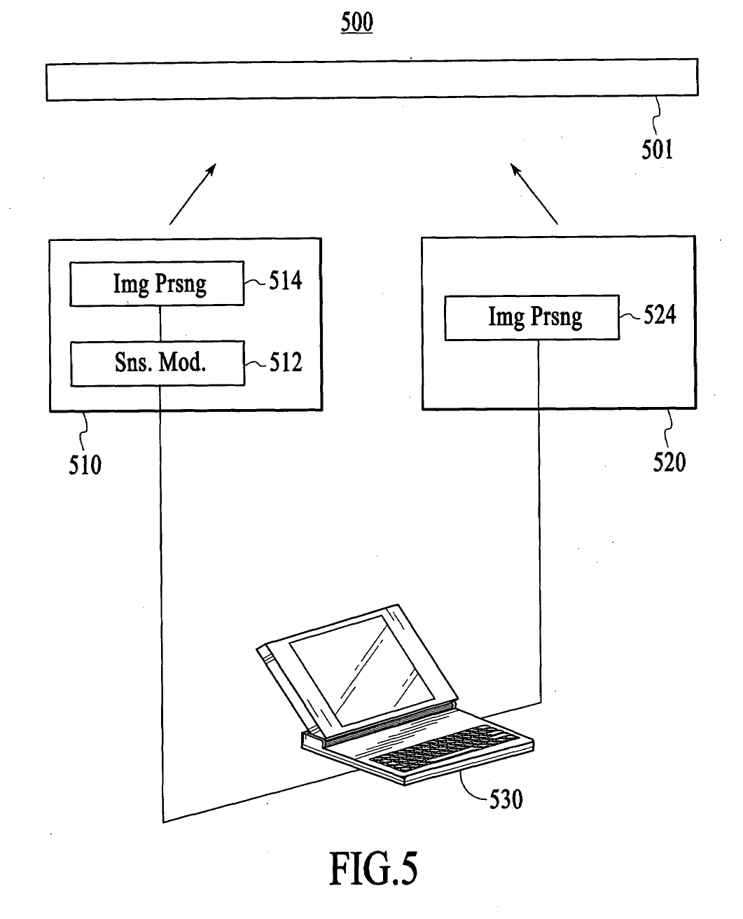

In accordance with an embodiment, the image projection device 300 can be implemented with another image projection device to create a multi projector display system whereby overlapping images can be displayed. FIG. 5 shows a multi projector display system 500 in accordance with an embodiment. The system 500 includes at least two projectors 510, 520 for projecting large area, high resolution tiled displays onto a display screen 501 whereby the leftmost projector 510 includes a sensing module 512 coupled to an image processing mechanism 514. Projector 520 also includes an image processing mechanism 524. The system 500 further includes a computer 530 for communicating with the projectors 510, 520 via the respective image processing mechanisms 514, 524. Various commercially available computers can be used for computer 530, for example, a personal computer or laptop computer.

In the system 500, the method for displaying at least two projected overlapping images is accomplished by re-imaging a projected image from adjacent projector 520 onto the photosensors of the sensing modulator of the leftmost projector 510. This involves projecting a scanned calibration pattern from the second projector 520 over the photesensor position of the leftmost projector 510. By projecting a scanned calibration pattern from the second projector 520 onto the display screen 501, and re-imaging the scanned calibration pattern over the photesensor position of the leftmost projector 510, the relative position of the overlapping projected images can be determined to within one pixel.

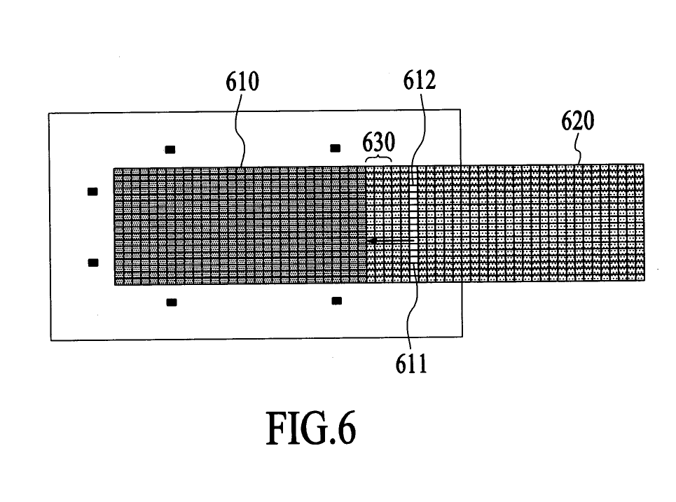

FIG. 6 shows two overlapping projected arrays on a screen in accordance with an embodiment. FIG. 6 shows the first projected array 610 from the leftmost projector (element 510 in FIG. 5) and the second projected array 620 from the second projector (element 520 in FIG. 5). Once the projected arrays 610, 620 have been determined to be overlapping arrays, calibration of the overlapping images takes place whereby the photosensors 611, 612 of leftmost projector pick up the relative position of the second projected array 620. Since the position between the edge of the array 610 and the photosensors is accurately known, once the relative position of the second projected array 620 is picked up, the number of overlapping pixels 630 can quickly be determined. Once the number of overlapping pixels 630 are determined, the overlapping projected arrays 610, 620 can be programmatically merged by tapering or deleting the overlapping pixels 630.

Furthermore, in order to increase the Signal to Noise ratio, reduce noise and reject ambient illumination, an alternate embodiment includes measuring the photosensor signal differentially whereby two photosensors are used and only the differential signal is measured. In this instance, the sensor spacing and calibration image are chosen so that one of the two photosensors detects the signal from the calibration image while the other sensor detects only the screen ambient.

In addition to calibrating for adjacent image position, the photosensors may be employed to calibrate the image brightness, color balance and the relative projector focus. For color calibration, the scanned calibration image projected from one projector could include sequential imaging of each primary color (red, blue and green) whereby the results are stored. Alternatively, two different primary colors could be scanned simultaneously at the differential photosensor spacing thereby generating a differential color signal directly.

Furthermore, in order to detect the calibration images at a sufficient signal to noise ratio, the illumination to the sensing modulator could be cut off during calibration. For Light Emitting Diode (LED) or laser illumination this would not be problematic, but for Ultra High Pressure Mercury lamp illumination, a shutter would probably need to be installed in the illumination path.

Finally, although the above-described embodiment is disclosed in the context of being implemented with a computer 530, it should be understood that the inventive concept is not limited to this particular embodiment. For example, two projectors could be implemented whereby the calibration of the two overlapping images is performed with one or both of the respective image processing mechanisms.

A sensing modulator and a method of use thereof is disclosed. In an embodiment, the sensing modulator includes a light modulator array and a plurality of photosensors wherein each of the plurality of photosensors are adjacent to the light modulator array. Accordingly, the modulator provides for the registration of multiple projection images to within 1 pixel as well as brightness and color calibration between the images. From the end user perspective, no hardware is needed other than the individual projectors and the only setup procedure required is to guarantee that the multiple projected images overlap.

Without further analysis, the foregoing so fully reveals the gist of the present inventive concepts that others can, by applying current knowledge, readily adapt it for various applications without omitting features that, from the standpoint of prior art, fairly constitute essential characteristics of the generic or specific aspects of this invention. Therefore, such applications should and are intended to be comprehended within the meaning and range of equivalents of the following claims. Although this invention has been described in terms of certain embodiments, other embodiments that are apparent to those of ordinary skill in the art are also within the scope of this invention, as defined in the claims that follow.

1. A sensing modulator comprising
a light modulator array; and
a plurality of photosensors, each of the plurality of photosensors being adjacent to the light modulator array.

2. The modulator of claim 1 wherein at least one of the photosensors comprises a silicon sensor.

3. The modulator of claim 2 wherein the silicon sensor comprises a photodiode.

4. The modulator of claim 2 wherein the silicon sensor comprises a phototransistor.

5. A method for displaying at least two projected images comprising:
sensing at least one projected image with a sensing modulator;
determining a relative distance between the at least one projected image and another projected image;
programmatically merging the at least one projected image and the another projected image; and
displaying the merged at least one projected image and the another projected image.

6. The method of claim 5 wherein sensing the at least one projected image further comprises:
utilizing at least two photosensors to generate a differential signal.

7. The method of claim 5 wherein programmatically merging the at least one projected image and the another projected image further comprises:
determining an overlapping portion of the at least one projected image and the another projected image; and
calibrating the at least one projected image relative to the another projected image based on the overlapping portion.

8. The method of claim 7 wherein calibrating further comprises:
tapering the overlapping portion.

9. The method of claim 7 wherein calibrating further comprises:
deleting the overlapping portion.

10. The method of claim 7 wherein calibrating further comprises:
balancing a brightness of the overlapping portion.

11. The method of claim 7 wherein calibrating further comprises:
performing a color balance of the overlapping portion.

12. The method of claim 11 wherein performing a color balance further comprises:
sequentially calibrating image colors wherein the image colors comprise red, blue and green.

13. An image projection device comprising:
an image processing mechanism; and
a sensing modulator coupled to the image processing mechanism wherein the sensing modulator further comprises a light modulator array and a plurality of photosensors, each of the plurality of photosensors being adjacent to the light modulator array.

14. The image projection device of claim 13 wherein at least one of the photosensors comprises a silicon sensor.

15. The image projection device of claim 14 wherein the silicon sensor comprises a photodiode.

16. The image projection device of claim 14 wherein the silicon sensor comprises a phototransistor.
